(19) United States
(12) Patent Application Publication
(10) Pub. No.: US 2008/0060024 A1
(43) Pub. Date: Mar. 6, 2008

(54) Wirelessly transmitting programming obtained from a satellite system

(76) Inventor: Bart Decanne, Austin, TX (US)

Correspondence Address: TROP PRUNER & HU, PC, 1616 S. VOSS ROAD, SUITE 750, HOUSTON, TX, 77057-2631, US

(21) Appl. No.: 11/514,040

(22) Filed: Aug. 31, 2006

(51) Int. Cl. H04N 7/20

(52) U.S. Cl. 725/72; 725/68; 725/63

(57) ABSTRACT

In one embodiment, an antenna enclosure associated with a satellite antenna may include a converter to downconvert incoming radio frequency (RF) signals from a first frequency to a second frequency, a receiver to receive the second frequency signals and to tune to at least one requested signal channel, and a wireless interface to receive and wirelessly transmit the at least one requested signal channel.

### FIELD OF THE INVENTION

Embodiments of the present invention relate to a satellite system, and more particularly to implementations of a satellite receiver.

### BACKGROUND

Various satellite systems are used to transmit and receive different types of data. One common satellite system is used for transmission of television programming via a direct to-home (DTH) system in which a satellite system is used by a service provider to transmit television programming to customers having a satellite receiver that receives and processes satellite spectrum signals to obtain desired programming. Typical DTH system installations include a so-called dish antenna, which is often located on a roof or other outer location of a home. The dish antenna receives the satellite signals, which are typically transmitted at a frequency of around 12 GHz. The incoming signals are provided through an enclosure of the dish antenna, which includes typically a low-noise block (LNB) converter that downconverts the incoming signals to an intermediate frequency (IF) band, typically the L-band between approximately 1-2 GHz. In turn, this signal is provided to a receiver that is typically included in a set-top box (STB) within the home, which processes the signal to provide programming to a television or other device to which the set-top box is coupled.

Installation of such systems can be complex, time-consuming and expensive. Generally, a coaxial cable is used to connect the dish antenna from its external location to the in-home set-top box. As satellite signals are transmitted on two polarizations (horizontal vs. vertical polarization, or alternatively, right-handed vs. left-handed circular polarization) two coaxial cables from the dish antenna are used to route signals downstream to the point of a “multi-switch” peripheral device. The “multi-switch” selects a frequency band corresponding to one of both polarizations for the downstream feed to the in-home STB. The multi-switch receives a polarization selection signal from the in-home STB. This coaxial wiring and peripheral equipment increase the cost and complexity of installation. Furthermore, such cable runs are typically limited to 100 feet or less, due to signal attenuation issues at the high IF frequencies used.

Sometimes it is desired to provide satellite programming to multiple televisions or even to multiple dwelling units (MDU's) from a single receive antenna, as for instance is the case in an apartment complex which offers satellite TV subscriptions from a single dish antenna installation—a so-called satellite master antenna TV (SMATV) scenario. To keep full flexibility for tuning to both polarizations by each connected receiver, frequency bands of both polarizations need to be fed to each receiver or dwelling unit. Typically in this case additional infrastructure equipment is used to frequency-multiplex the bands of both polarizations onto a single coaxial cable—a so-called “staggered-LNB” scenario. This results in additional costs because of: (1) the cost of the additional equipment at the antenna side; (2) use of specific set-top boxes that are able to receive the wider frequency band inputs, instead of more common set-top boxes that send out a selection signal to only receive the frequency band of the selected polarization; and (3) a further reduction in maximum cable length as a wider, higher frequency band is used on the coaxial cable, resulting in additional cable attenuation loss.

As additional programming services are provided, a need has developed to extend beyond the 1-2 GHz IF band for downconverted satellite spectrum signals. To overcome this limitation, some systems provide LNB's with channel filtering and a frequency-agile down-mixer within a single antenna enclosure to selectively downconvert, per LNB, a small number of adjacent satellite transponders. Increasing the number of LNB converters requires a proportional increase in the amount of control signaling sent from set-top box to the antenna enclosure. While this scheme enables the use of only a single coaxial cable to one or multiple receivers, and hence reduces installation costs, this comes at the expense of equipment costs due to the multi-LNB requirement inside the antenna enclosure.

Coaxial cabling is also typically used to provide power to the dish antenna and assembly. Typically, a DC power signal, e.g., at 13 or 18 volts, is sent from set-top box to antenna enclosure. The LNB command signaling mentioned earlier is transmitted as a low-frequency AC-signal superimposed onto this DC power signal As a typical LNB converter consumes approximately 500 mA, power is transmitted at relatively high currents, which is present on the same coaxial cable as that used to receive sensitive satellite input signals, raising the potential for signal interference.

### SUMMARY OF THE INVENTION

In one aspect, the present invention is directed to an antenna enclosure that may be associated with a satellite antenna. The antenna enclosure may include various components to receive and process incoming radio frequency (RF) signals from the antenna. In one implementation, the antenna enclosure may include a converter to convert the RF signals from a first frequency to a second frequency, a receiver (which in one embodiment may be a single chip integrated circuit including at least a tuner and a demodulator) to receive the second frequency signals and to tune to a requested signal channel, and a wireless interface to receive and wirelessly transmit the requested signal channel. The wireless interface may be controlled by a client device within a wireless local area network (WLAN) with the antenna enclosure to wirelessly transmit the requested signal channel at a bit rate requested by the client device. The antenna enclosure may be ruggedized to withstand conditions when located in an external environment.

In some embodiments, the wireless interface may further include a transcoder, which may be coupled to the demodulator of the receiver, to transcode the requested signal channel to a different bit rate or source coding format requested by a client device. Further still, the antenna enclosure may include a re-multiplexer to combine bitstreams from multiple receivers to generate a re-multiplexed bitstream including desired programming. In some implementations, the antenna enclosure may include a bypass of the full receiver (i.e., tuner and demodulator), so that I.F. signals from the LNB/mixer may be sent directly to the wireless interface for digitization and wireless transmission. In this case I.F. tuning and demodulation occur in a client device. Alternatively the bypass is only for the demodulator part of the receiver, and a baseband or low-IF signal from the tuner is sent to the wireless interface with final demodulator occurring at a client device.

Another aspect of the present invention resides in a method for wirelessly receiving a request for satellite programming in an antenna enclosure of a satellite system from a client device in a wireless network in which the satellite system is present, tuning to a transponder channel including a requested channel within a satellite spectrum using a receiver of the antenna enclosure, and wirelessly transmitting the requested channel from the antenna enclosure. During operation, multiple requests may be received from multiple client devices, and may be handled to provide programming services to each requesting client device. When a client device wirelessly receives requested programming, it may then forward one or more of the same to a second device coupled to the client device, e.g., via a wide area network.

A still further aspect of the present invention is directed to a system that includes a satellite antenna to receive satellite signals and an antenna enclosure to couple to the satellite antenna. The antenna enclosure may include a converter to downconvert incoming RF signals from the satellite antenna to an intermediate frequency, a receiver to receive the intermediate frequency signals and to tune to a transponder including multiple programming services and to generate a bitstream from the transponder, and a wireless interface to receive and wirelessly transmit the bitstream to a client device in a wireless network with the antenna enclosure.

### BRIEF DESCRIPTION OF THE DRAWINGS

FIG. 1 is a block diagram of a system in accordance with one embodiment of the present invention.

FIG. 2 is a block diagram of a wireless network in accordance with one embodiment of the present invention.

FIG. 3 is a block diagram of a system in accordance with one embodiment.

FIG. 4 is a flow diagram of a method in accordance with one embodiment of the present invention.

### DETAILED DESCRIPTION

In various embodiments, a satellite receiver front end may be located within a dish antenna enclosure, also referred to herein as an antenna housing. In this way, front end processing of the satellite spectrum signals can be performed in close proximity to the antenna which benefits receiver sensitivity. The processing includes down-mixing the received input RF satellite spectrum (e.g., approximately 12 GHz), typically in two steps: first to an IF frequency band (e.g., L-band: 1-2 GHz), followed by an IF tuning to generate a baseband or low IF signal. While the signal may be digitized after either of these steps, in many embodiments a demodulation function may also be performed within the antenna housing. The output of such a demodulator is a digital bitstream, such as, e.g., an MPEG-2 transport stream format typically used in satellite DTV. This bitstream is fed to a transceiver, also located in the enclosure. The transceiver may be a wireless transceiver, for example, a so-called WiFi transceiver in accordance with a given IEEE 802.11 standard such as an 802.11n standard, or other present or future wireless transmission protocols. In this way, ubiquitous reception of satellite signals via an in-home wireless network or a remote location coupled thereto may be realized. Furthermore, the need for coaxial cabling or other wiring can be avoided.

By enabling wireless transmission, reception of satellite programming may be realized by a variety of client devices having wireless capabilities. For example, in many implementations, PDAs, PCs, laptops, portable gaming devices, cell phones, among many other such devices may receive and display satellite television programming via a wireless connection to the dish antenna enclosure.

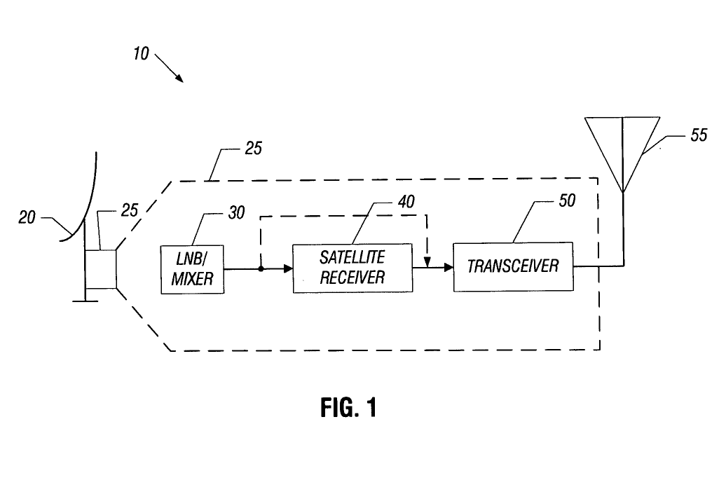

Referring now to FIG. 1, shown is a block diagram of a system in accordance with one embodiment of the present invention. As shown in FIG. 1, system 10 may be used to receive and process satellite signals in a DTH system and includes a dish antenna 20, which may be positioned at an external location of a home, for example, on the roof. Typically, dish antenna 20 is positioned to maintain a line of sight to a given satellite. Antenna 20 is typically mounted to its location along with an enclosure 25. As shown in FIG. 1, enclosure 25 includes an LNB/mixer 30 coupled to receive incoming RF signals. LNB/mixer 30 may receive incoming satellite signals, e.g., at 12 GHz and downconvert them to an intermediate frequency band (e.g., between 1-2 GHz). The downconverted satellite signals may then be provided to a satellite receiver 40, which typically includes both IF tuner and demodulator functions. The IF signal may further be demodulated to produce a digital bitstream which contains one or more desired radio and/or video channels, typically in a compressed format such as the MPEG-2 transport stream format. This transport stream may be provided to a transceiver 50 that further encodes the signals for wireless transmission via a given protocol, such as a WiFi or WiMax protocol. Accordingly, signals may be received by any given device within a wireless network range of enclosure 25. While shown with this particular configuration in the embodiment of FIG. 1, the scope of the present invention is not limited in this regard and in other embodiments, additional circuitry may be present within an antenna enclosure. Furthermore, as shown in FIG. 1, in some implementations a downconverted RF signal (i.e., analog IF signal) may be directly provided from LNB/mixer 30 to transceiver 50 via a bypass path. In such implementations, transceiver 50 may include an analog-to-digital converter (ADC) to digitize the downconverted signal, which may then be remodulated for wireless transmission. Still further, in some implementations a downconverted IF signal may be downmixed to baseband, or low-IF, by the tuner portion of a satellite receiver 40, and then this analog baseband, or low-IF, signal may similarly be directly provided to transceiver 50 for sampling and remodulation for transmission. In this way, at least portions of the satellite spectrum may be directly sent to transceiver 50 so that final demodulation may occur in a client device.

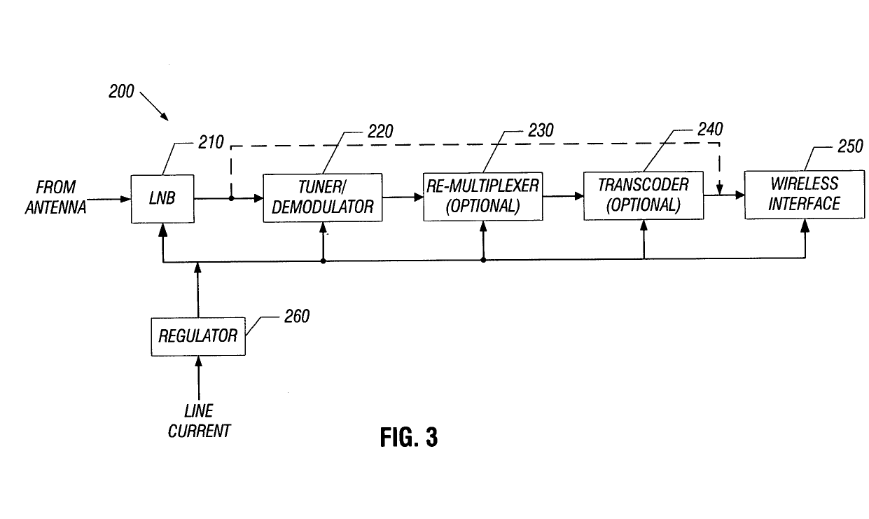

Note that in various embodiments, a transport stream from satellite receiver 40 may be a single digital stream corresponding to a selected TV or radio channel. In other embodiments, multiple programming services, present within the bandwidth of a single down-converted satellite transponder may be output from satellite receiver 40. In a more advanced embodiment, multiple programming services compiled from a number of transponders may be generated when the satellite receiver is a multi-channel receiver. Transceiver 50 may remodulate the transport stream, which can be potentially re-multiplexed in some implementations by combining the selected programming services. In addition to remodulation, it is also possible to optionally alter the bit rate and/or source coding method of the signal when converting to the desired wireless protocol. For instance the source coding can be changed from MPEG-2 to MPEG-4 (“transcoding”), or the bitrate of an MPEG-2 signal can be reduced without changing the source coding method (“transrating”). This optional process will be described further with regard to FIG. 3.

In various embodiments, satellite receiver 40 may be a single-chip CMOS device. In this way, there are reduced components for tuning. Furthermore, the feature integration may improve reliability, allowing the receiver to operate over a greater range of environmental conditions, so it can be placed within an external environment, i.e., within antenna enclosure 25. While the highly integrated device can, e.g., include automatic performance calibration to ensure performance over widely varying environmental conditions, a component-based receiver, including many discrete components, on the other hand may suffer from degraded performance or failure at the various temperature levels to which an external enclosure may be subjected. Furthermore via the use of a single-chip receiver, multiple receivers may be adapted on the chip, enabling parallel receipt and processing of the data from multiple satellite transponders to provide simultaneous feeds to, e.g., different downstream devices, as explained above.

By elimination of a coaxial cable to antenna enclosure 25, installation expenses may be reduced. To provide power to antenna enclosure 25, a standard power cable may be provided to enable ordinary household line currents to power to the enclosure, avoiding the need for superimposing a power signal over a coaxial cable receiving the RF feed.

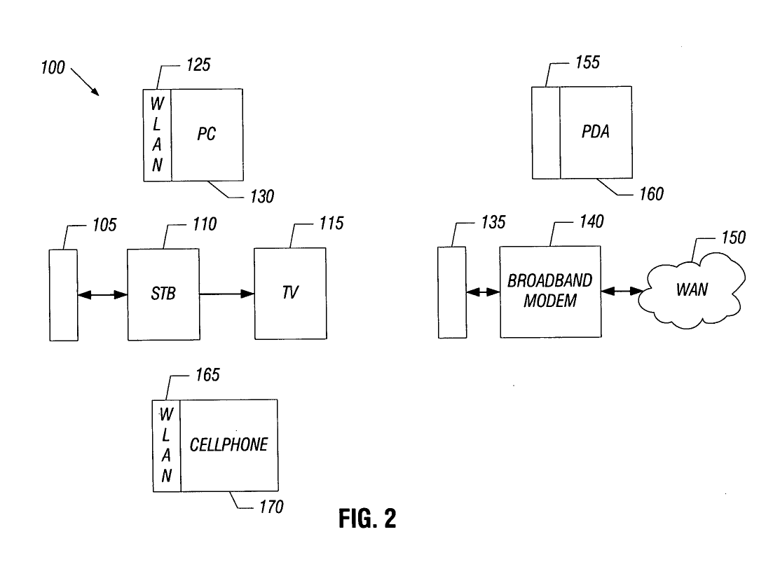

A wireless local area network (WLAN) in which system 10 is adapted to operate may allow for various types of client devices to receive wireless signals from antenna enclosure 25. Referring now to FIG. 2, shown is a block diagram of a wireless network in accordance with one embodiment of the present invention. As shown in FIG. 2, network 100 may be a home WLAN, for example, although the scope of the present invention is not limited in this regard. In network 100, various client devices may be adapted to receive wireless signals from antenna enclosure 25. As shown in FIG. 2, such devices include a set-top box 110, a PC 130, a broadband modem 140, a PDA 160, and a cellular telephone 170. Of course, additional devices may be present and adapted to receive wireless signals. Each of these devices may include an integrated wireless receiver, or may have an adapter coupled thereto to act as a wireless interface with respect to the wireless network. Accordingly, as shown in FIG. 2, a wireless adapter 105 is coupled to receive wireless signals and provide RF signals to set-top box 110. In turn, set-top box 110 is coupled to a television 115, which may be a flat screen panel such as a liquid crystal display or a plasma television, for example. A WLAN interface 125, which may be an integrated wireless component within PC 130, may similarly receive wireless signals and provide digital signals to, e.g., processing circuits within PC 130.

An adapter 135 may be coupled to broadband modem 140 to receive wireless signals and provide Internet protocol (IP) signals to broadband modem 140. In turn, broadband modem 140 may provide ethernet signals to a wide-area network (WAN) 150 to which various other devices may be coupled. Hence embodiments of the present invention may be extended from a wireless home network to a WAN or the wider Internet to enable “place-shifting,” i.e., viewing of TV in a different location from where the receive antenna is installed, possibly in combination with a “time-shifting” feature, described below. The 2-way nature of the Internet makes channel selection and other control readily available from such a remote location. Similarly, PDA 160 and smart phone 170 may include WLAN interfaces 155 and 165, respectively.

Via wireless connections, each of these devices within network 100, or possibly beyond the range of network 100 (e.g., via a WAN), may receive and use satellite programming. For example, programming may be displayed on a display of the device. Alternately, a device such as a personal video recorder, e.g., present in set-top box 110 or PC 130, may store a program for later viewing (“time-shifting”). Additionally, each of the devices may independently control satellite receiver 40 within antenna enclosure 25 via two-way wireless communication. That is, each of the devices may request a particular channel via transmission of a channel request over the accompanying wireless interface.

In some implementations, the bitstream to be transmitted may be encrypted. Various encryption protocols may be used. Furthermore, various smart card or similar functionality, e.g., via an encryption device, may be present within antenna enclosure 25. Similar decryption protocols may be present in downstream devices such as set-top boxes, PC's or other devices. Note further that an inherent wired equivalent privacy (WEP) protocol or similar encryption protocol may protect wireless transmission of programming data.

Different downstream devices may request data according to different protocols, e.g., different bandwidths depending on capabilities. Accordingly, multiple channels of data may be sent at a lower bit rate responsive to a downstream device's request. Similarly, based on a downstream device's request, the wireless data may be transcoded to a different protocol to enable reduced bit rates, greater speeds, or other desired features. For example, portable devices such as a PDA, cellular device, or a laptop computer may request data of a lower video quality, as the devices are only capable of a certain amount of resolution. Accordingly, transmission can be effected at reduced bit rates according to a given modulation scheme. In this way, additional channels may also be transmitted, e.g., to allow the device to simultaneously stream one channel while recording a separate channel for later viewing.

FIG. 3 is a block diagram of a system in accordance with one embodiment. As one example, system 200 may be included in an antenna enclosure of a DTH system, for example. Of course, embodiments of the present invention may be used in connection with other systems. Incoming signals from an antenna are provided to a LNB converter 210 that converts the incoming satellite signals, e.g., at a 12 GHz frequency to an IF signal band that can then be processed by a tuner/demodulator 220. However note that in some implementations, as described above, an analog IF signal may be provided directly from LNB 210 to a wireless interface 250 for sampling and then transmission, in which case final demodulation occurs at a client device.

In many implementations, however, IF band signals may instead be provided to tuner/demodulator 220. This IF band can contain, for example, a number of transponders between 950 MHz and 2150 MHz with each transponder carrying a number of different digital programming services (TV, radio, among other services). In other implementations, a wider bandwidth IF receiver accommodating multiple transponders may be present. This signal spectrum can be processed by tuner/demodulator 220 to provide a digital baseband output signal that represents the bitstream modulated onto one or multiple transponders. Optionally, a re-multiplexer 230 may be used to filter selected programming services from this/these bitstream(s) and to re-multiplex a new bitstream containing only the selected services. For example, in a system in which multiple tuners/demodulators 220 are present, selected channels from each of the demodulated bitstreams may be obtained, e.g., via filtering. The selected channels may then be combined, e.g., re-multiplexed to obtain a bitstream that only includes the desired programming.

Note that in addition to the signal processing chain between the components within system 200, a connection to each component is present from wireless interface 250. In various embodiments, wireless interface 250, which will be discussed further below, may be used to provide control signals received from one or more client devices in order to control the components of system 200 to enable tuning to desired programming.

The tuned channels from tuner/demodulator 220 (or re-multiplexer 230) may be provided to a transrater/transcoder 240, if present. Transcoder 240 may be present in certain embodiments to enable transcoding of the channels to a format more suitable to a receiving device. For instance, the original source coding format can be changed altogether to improve coding efficiency (e.g., MPEG-2 to MPEG-4 or H.264 source coding). Also, depending on a client device's capabilities, a transcoder can apply parametric bit rate reduction techniques to reduce the bit rate directly in the compressed domain without changing the source coding method. The output of transrater/transcoder 240 may be fed to wireless interface 250 for remodulation to the target wireless network.

Wireless interface 250 may include transceiver functionality to enable transmission of wireless signals, along with reception of wireless signals, e.g., control signals from client devices. In one embodiment, wireless interface 250 may be in accordance with a given WLAN protocol, such as an IEEE 802.11 protocol, a WiMax protocol, or other wireless protocol. Note that in various embodiments, the components of system 200 may be enclosed within an antenna enclosure adapted for external location. To enable reduced size and power consumption, in some implementations some or all of the components within system 200 shown in FIG. 3 may be implemented in a single integrated circuit (IC). That is, at least tuner demodulator 220, re-multiplexer 230, transcoder 240, and wireless interface 250 may be formed on a single substrate of an IC. As further shown in FIG. 3, a regulator 260 may be coupled to receive an incoming line current. Regulator 260 may generate one or more regulated voltages as needed by the different components within system 200. Accordingly, one or more voltage outputs from regulator 260 may be coupled to each of the components within system 200. While shown with this particular implementation in the embodiment of FIG. 3, the scope of the present invention is not limited in this regard.

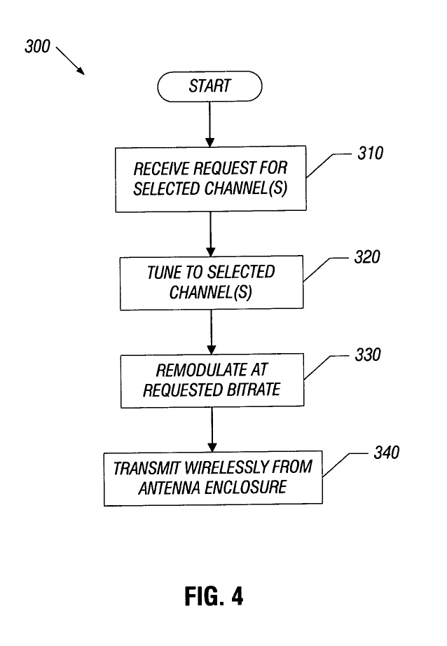

Referring now to FIG. 4, shown is a flow diagram of a method in accordance with one embodiment of the present invention. As shown in FIG. 4, method 300 may be used to effect control and transmission of wireless programming data between an antenna enclosure and one or more client devices. A shown in FIG. 4, method 300 may begin by receiving a request for one or more selected channels (block 310). Such requests may come from one more client devices within a WLAN in which the antenna enclosure is located. For example, a set-top box associated with a TV may send a first request for given programming, while a portable device such as a PDA, PC, or cellular telephone also located within the WLAN may send different requests for other programming. The requests may be received by the wireless interface and used to control various components of the antenna enclosure, including the LNB/downconverter, tuner, demodulator, transrater/transcoder and wireless interface, in addition to LNB polarization selection, etc.

Referring still to FIG. 4, based upon the request, the receiver may tune to the selected channel(s) (block 320). After tuning, additional signal processing, such as demodulation may occur. Then, at block 330 remodulation may be performed to re-modulate the demodulated signals to a requested bit rate or other modulation scheme. For example, the set-top box may request high quality video signals and may have sufficient processing capacity to handle high-quality video signals at a high bit rate. However, another device, such as a portable device having a lower quality video capability, may request transmission at a lower bit rate to reduce consumption of its resources and further to receive a lower quality video signal more appropriate for its capabilities. After such remodulation, the signals may be wirelessly transmitted from the antenna enclosure (block 340). There, the wireless interface may again process the signals to wirelessly transmit them according to a given protocol and with various encryption capabilities, such as WEP encryption. While shown this particular implementation in the embodiment of FIG. 4, it is to be understood that the scope of the present invention is not limited in this regard.

The methods described herein may be implemented in software, firmware, and/or hardware. A software implementation may include an article in the form of a machine-readable storage medium onto which there are stored instructions and data that form a software program to perform such methods. As an example, a DSP may include instructions or may be programmed with instructions stored in a storage medium to perform wireless transmission of satellite programming in accordance with an embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an antenna enclosure associated with a satellite antenna, the antenna enclosure including a converter to downconvert incoming radio frequency (RF) signals from a first frequency to a second frequency;
the antenna enclosure further including a receiver to receive the second frequency signals and to tune to at least one requested signal channel; and
the antenna enclosure further including a wireless interface to receive the at least one requested signal channel and to wirelessly transmit the at least one requested signal channel.

2. The apparatus of claim 1, wherein the wireless interface is to wirelessly transmit the at least one requested signal channel at a bit rate requested by a first client device within a wireless local area network (WLAN) including the antenna enclosure.

3. The apparatus of claim 1, wherein the antenna enclosure comprises an environmental enclosure to be located in an external environment.

4. The apparatus of claim 3, wherein the antenna enclosure comprises a transformer to receive power from a line current.

5. The apparatus of claim 1, wherein the receiver comprises a single chip integrated circuit including a tuner and a demodulator.

6. The apparatus of claim 5, further comprising a transcoder coupled to the demodulator, wherein the transcoder is to transcode the at least one requested signal channel to a different bit rate or source coding requested by a client device.

7. The apparatus of claim 1, wherein the wireless interface is to wirelessly receive control information from a client device and to communicate the control information to the receiver.

8. The apparatus of claim 1, wherein the receiver comprises a first tuner and a second tuner, each to receive the second frequency signals, wherein each tuner is independently controllable by multiple client devices.

9. The apparatus of claim 8, wherein the first tuner is to output a single requested signal channel responsive to a request from a first client device and the second tuner is to output a plurality of requested signal channels responsive to a request from the second client device.

10. The apparatus of claim 9, wherein the wireless interface is to wirelessly transmit the single requested signal channel and the plurality of requested signal channels at different bit rates responsive to the requests from the first and second client devices.

11. The apparatus of claim 1, wherein the converter is to provide the downconverted signals of the second frequency directly to the wireless interface, wherein the wireless interface is to digitize the downconverted signals of the second frequency.

12. A method comprising:
wirelessly receiving a request for satellite programming in an antenna enclosure of a satellite system from a client device in a wireless network in which the satellite system is present;
tuning to a transponder channel including a requested channel within a satellite spectrum using a receiver of the antenna enclosure; and
wirelessly transmitting the requested channel from the antenna enclosure.

13. The method of claim 12, further comprising receiving multiple requests for satellite programming from multiple client devices in the antenna enclosure.

14. The method of claim 13, further comprising tuning to the multiple requested channels using multiple receivers of the antenna enclosure.

15. The method of claim 12, further comprising controlling the receiver based on control signals received from the client device.

16. The method of claim 12, further comprising receiving power in the antenna enclosure from a line current and regulating the power to provide an operating voltage for the receiver.

17. The method of claim 12, further comprising:
demodulating the tuned transponder channel to obtain the requested channel; and
remodulating the tuned requested channel in response to a command from the client device.

18. The method of claim 17, wherein the remodulating comprises changing at least one of a bit rate and a coding scheme for the tuned requested channel.

19. The method of claim 17, further comprising lowering a video quality of the tuned requested channel via the remodulating, wherein the client device comprises a portable device.

20. The method of claim 12, wherein the client device is to wirelessly receive the requested channel and forward the requested channel to a second device coupled to the client device via a wide area network.

21. A system comprising:
a satellite antenna to receive satellite signals;
an antenna enclosure to couple to the satellite antenna, the antenna enclosure including a converter to downconvert incoming radio frequency (RF) signals from the satellite antenna from a first frequency to an intermediate frequency;
the antenna enclosure further including a receiver to receive the intermediate frequency signals and to tune to at least one transponder including a plurality of programming services and to generate a bitstream corresponding to the at least one transponder; and
the antenna enclosure further including a wireless interface to receive the bitstream and to wirelessly transmit the bitstream to a client device in a wireless network with the antenna enclosure.

22. The system of claim 21, further comprising:
a transrater and/or transcoder coupled to the receiver to remodulate the at least one requested signal channel to reduce a bit rate of the bitstream responsive to a request by a client device; and
a re-multiplexer coupled between the receiver and the transrater and/or transcoder to filter the bitstream and generate a re-multiplexed bitstream including only requested programming services.

23. The system of claim 21, further comprising a bypass path coupled to provide the downconverted intermediate frequency signals to the wireless interface.

24. The system of claim 21, wherein the wireless interface is to wirelessly transmit a first requested signal channel and a plurality of requested signal channels at different bit rates responsive to requests from the client device and a second client device.

25. The system of claim 21, wherein the client device is to forward the at least one requested signal to a second device remotely coupled to the client device via a network connection.

26. The system of claim 21, further comprising a plurality of receivers to independently tune to different transponders.
